(19) United States
(12) Patent Application Publication
(10) Pub. No.: US 2010/0107823 A1
(43) Pub. Date: May 6, 2010

(54) Hose Clamp Pliers

(76) Inventor: Ming-Chieh WU, Taichung City (TW)

Correspondence Address: Dr. BANGER SHIA;Patent Office of Bang Shia, 102 Lindencrest Ct., Sugar Land, TX, 77479-5201, US

(21) Appl. No.: 12/687,852

(22) Filed: Jan. 14, 2010

Related U.S. Application Data
(63) Continuation-in-part of application No. 12/208,321, filed on Sep. 10, 2008.

(51) Int. Cl. B25B 31/00; B25B 7/02; B25B 7/12; B25B 7/14

(52) U.S. Cl. 81/9.3; 81/418; 81/399; 81/370

(57) ABSTRACT

A pair of hose clamp pliers comprises a pair of hose clamp pliers and two clamping plates. The pliers include two clamping ends capable of moving toward or away from each other. The two clamping plates are fixedly connected to the two clamping ends, and the respective clamping plates are formed with at least one opening. When in use, the two clamping plates are used to clamp the hose clamp, and the hose clamp pliers are used to fix the positions of the two clamping ends, so that the user can position the hose clamp without exerting a continuous force.

This application is a continuation in part of U.S. patent application Ser. No. 12/208,321, which claims the benefit of the earlier filing date of Sep. 10, 2008. Claim 1 of this application is revised from the previous claim 1 of the U.S. patent application Ser. No. 12/208,321, respectively, and claims 2-5 of this application are new.

### BACKGROUND OF THE INVENTION

1. Field of the Invention

The present invention relates to a pair of pliers, and more particularly to a pair of hose clamp pliers.

2. Description of the Prior Art

Conventionally, slim pipes, such as water hoses are often connected in such a way that the big-diameter pipe is forced onto the small-diameter pipe, and then a hose clamp is used to increase tight connection between the two pipes.

Referring to FIG. 1, which shows a pair of hose clamp pliers 10 disclosed in US 2008/041831, the hose clamp pliers 10 are used to clamp a kind of clamp 11 which is made of an iron plate bent into a ring-shape, and the clamp 11 has two protruding ends 111 to be clamped by two clamping plates 12 of the pliers 10. However, the pliers 10 only use the clamping plates 12 to claim the ends 111 of the clamp 11 but don't have any other positioning or restricting structures to maintain the clamping force. Therefore, the clamp 11 is likely to slip off the pliers 10 when being clamped.

Another conventional hose clamp pliers 20 disclosed in U.S. Pat. No. 4,386,431 is shown in FIG. 2, the clamping plates 21 of the hose clamp pliers 20 are formed correspondingly to the circular shape of the clamp 22. Therefore, besides clamping the two ends 221 such hose clamp pliers 20 can also hold the outer periphery of the clamp 22 tight to stabilize the clamping operation. However, the hose clamp pliers 20 can only use the ends of its clamping plates 21 to clamp the clamp 22, which restricts the clamping direction of the pliers 20. For example, when the work surrounding is too narrow for the pliers 20 to use the ends of the clamping plates 21 to clamp the clamp 22, the pliers 20 will be useless.

The present invention has arisen to mitigate and/or obviate the afore-described disadvantages.

### SUMMARY OF THE INVENTION

The primary objective of the present invention is to provide a pair of hose clamp pliers, which utilizes two clamping plates fixed on two clamping ends of the pliers to clamp the hose clamp, along the periphery of the two clamping plates are formed a plurality of protrusions which define gaps for holding the protruding portions of the hose clamp, thus maintaining a stable clamping effect. Furthermore, the hose clamp pliers can clamp the hose clamp in different directions, so that it can be adapted to different work requirements or environments, for example, in a narrow space.

In order to achieve the above objective, a pair of hose clamp pliers comprises: a pivoting body, a clamping head, a control body, an adjustment rod, a spring, and two clamping plates.

The pivoting body has one end provided with a screw and another end fixed to the clamping head and is pivoted to the clamping head, the pivoting body and the clamping head each have a clamping end, the clamping head is pivoted to one end of the control body, and the control body is pivoted to one end of the adjustment rod, another end of the adjustment rod abuts against the screw of the pivoting body, two ends of the spring are connected to the pivoting body and the clamping head, respectively.

The two clamping plates are respectively fixedly connected to the clamping ends of the clamping head and the clamping end of the pivoting body and the clamping head, each of the clamping plates includes an inner surface, an outer surface, two opposite lateral surfaces, a free end surface and a connecting end surface opposite the free end surface, the two lateral surfaces are located at both sides of the inner and outer surfaces of each of the clamping plates, the two clamping ends of the hose clamp pliers are fixed to the outer surfaces of the two clamping plates, and the two inner surfaces of the two clamping plates are opposite each other, each of the connecting end surfaces is located between the two lateral surfaces and connected to the clamping head and the pivoting body, respectively, each of the free end surfaces is located between the two lateral surfaces of each of the clamping plates, on an inner surface of each of the clamping plates are formed a plurality of protrusions which are arranged spaced along the two opposite lateral surfaces, the free end surface and the connecting end surface of each of the clamping plates.

A hose clamp to be clamped by the hose clamp pliers of the present invention includes an inner ring portion and an outer ring portion, the inner ring portion is formed by bending an elongated plate into a ring shape, one end of the inner ring portion is bifurcated to form two first protruding portions and a gap therebetween, and each of the first protruding portions is bent to form a first ear, another end of the inner ring portion is provided with a second protruding portion which is bent to form a second ear, the second protruding portion is received in the gap between the two first protruding portions, the outer ring portion is formed by bending an elongated plate into a ring shape, the outer ring portion is mounted outside the inner ring portion, when the hose clamp is clamped by the clamping plates of the hose clamp pliers, the two first ears are received in the gaps between any two neighboring protrusions of one clamping plate, while the second ear is received in a corresponding gap on another clamping plate.

With the protrusions formed along the periphery of the two clamping plates and the gaps defined by the protrusions, the hose clamp pliers can clamp the hose clamp in different directions, so that it can be adapted to different work requirements or environments, for example, in a narrow space.

### BRIEF DESCRIPTION OF THE DRAWINGS

FIG. 1 is a perspective view of a conventional hose clamp;

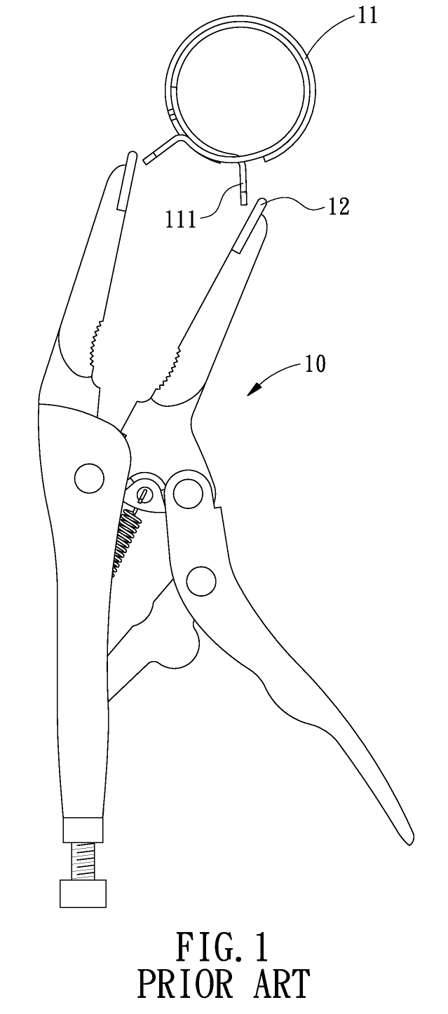

FIG. 2 is a perspective view of another conventional hose clamp pliers;

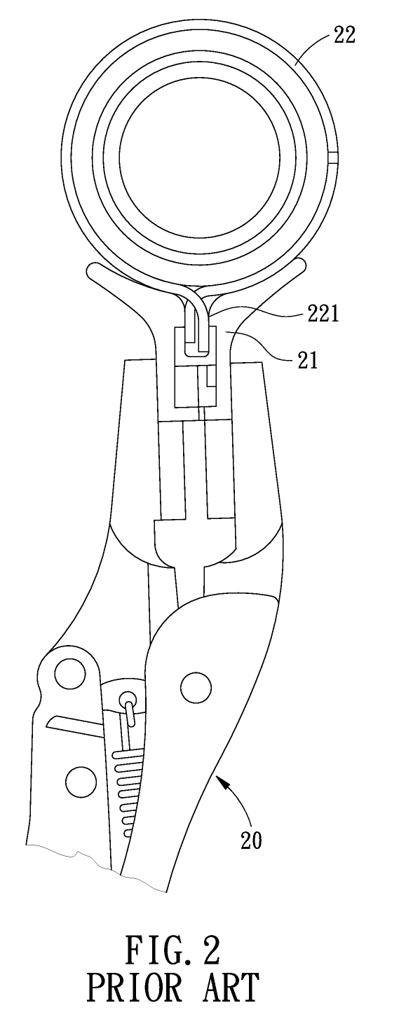

FIG. 3 is a perspective view of a pair of hose clamp pliers in accordance with the present invention;

FIG. 4 is an operational view showing that a hose clamp is being clamped on the hose by the hose clamp pliers in accordance with the present invention;

FIG. 5 is a schematic view illustrating the clamping plates of the hose clamp pliers in accordance with the present invention;

FIG. 6 is an amplified view showing that the hose clamp is being clamped by the hose clamp pliers in accordance with the present invention;

FIG. 7 is another amplified view showing that the hose clamp is being clamped by the hose clamp pliers in accordance with the present invention;

FIG. 8 is a side view showing that the hose clamp is clamped by the hose clamp pliers in accordance with the present invention;

FIG. 9 shows that the hose clamp is being clamped in lateral direction by the hose clamp pliers in accordance with the present invention; and

FIG. 10 is a top view showing that the hose clamp is being clamped on the hose by the hose clamp pliers in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

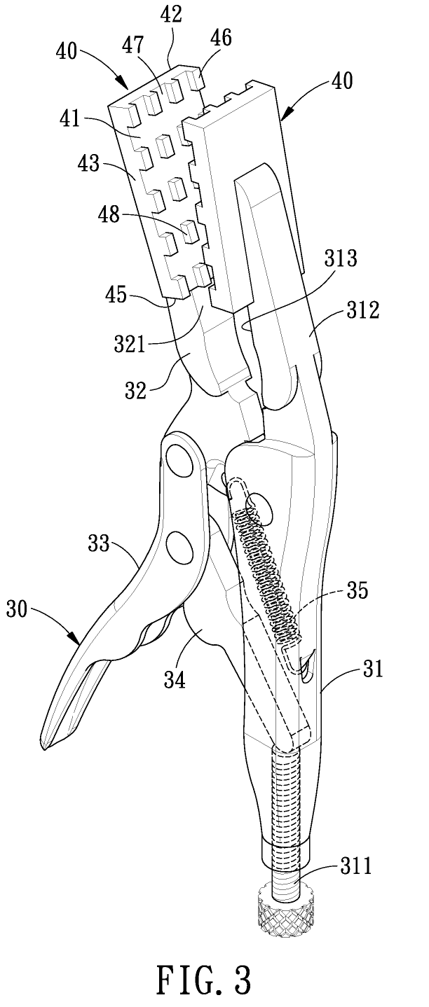

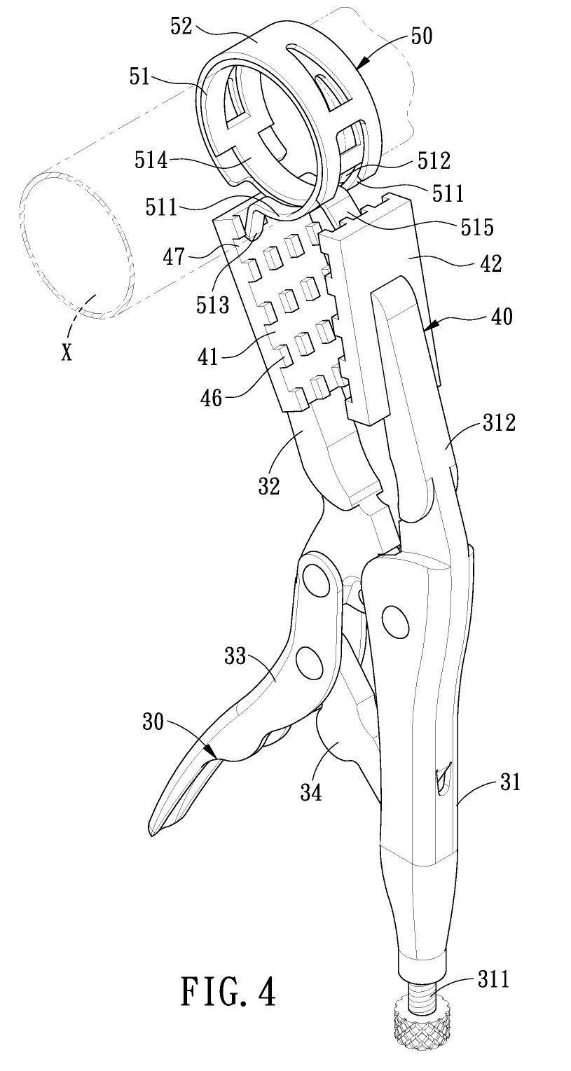

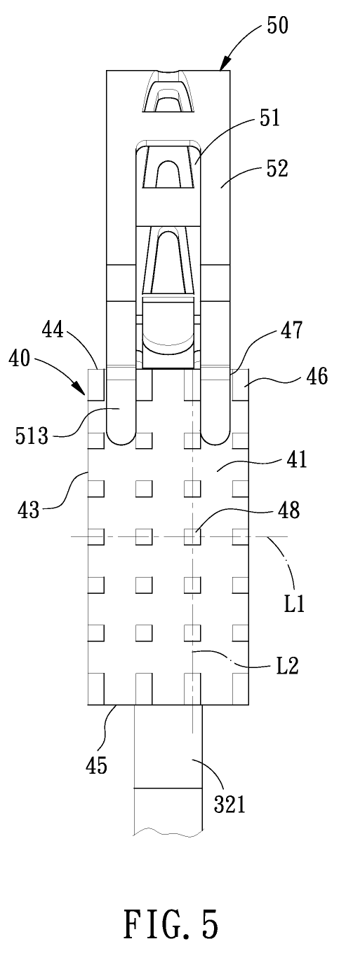

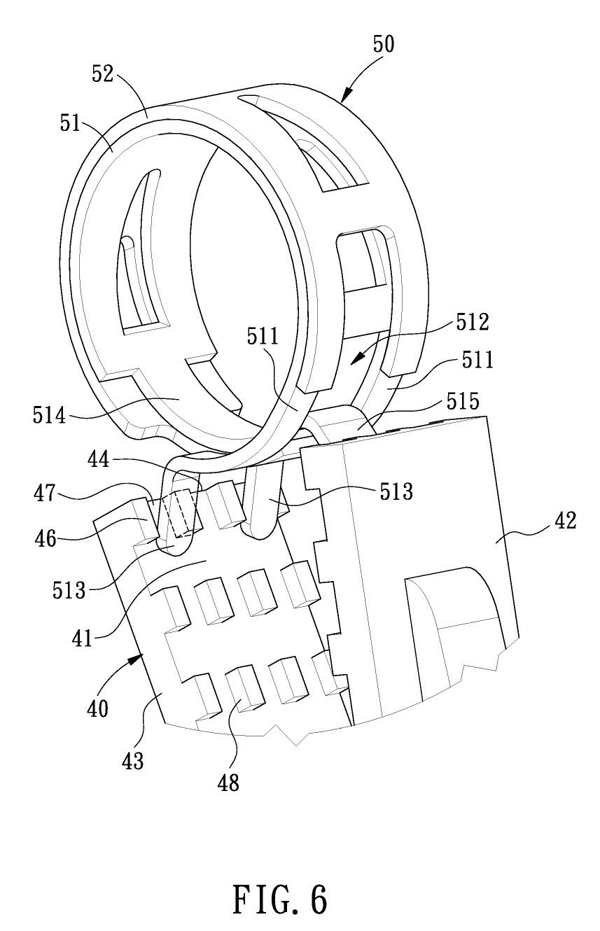

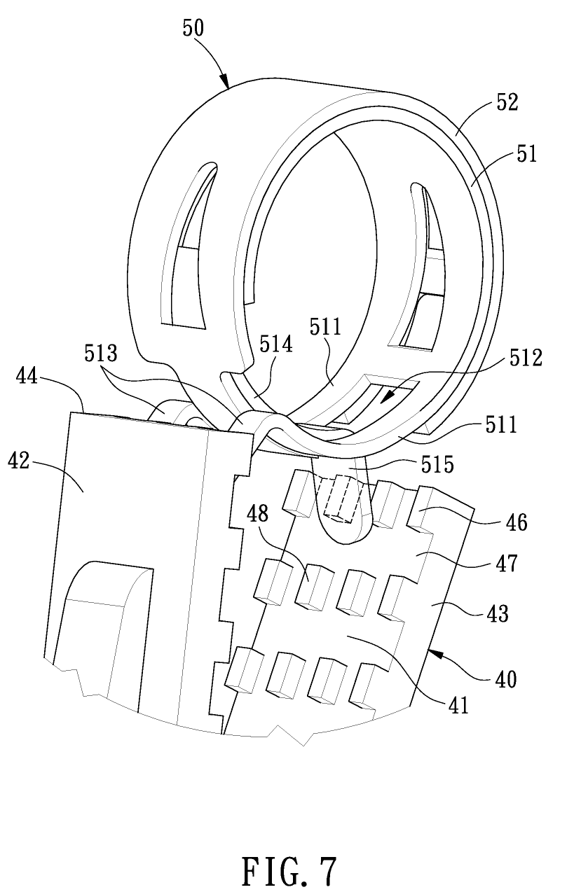

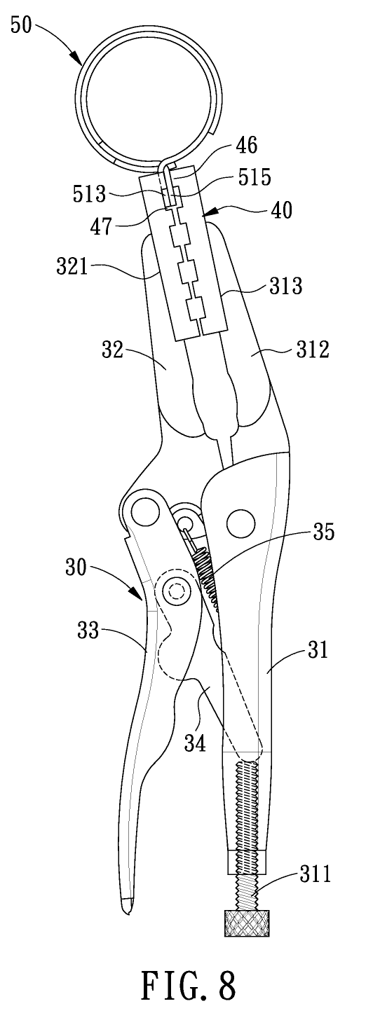

Referring to FIGS. 3-10, a pair of hose clamp pliers 30 in accordance with a preferred embodiment of the present invention comprises: a pivoting body 31, a clamping head 32, a control body 33, an adjustment rod 34, a spring 35 and two clamping plates 40. The pivoting body 31 has one end provided with a screw 311 and the other end fixed to the clamping head 32. The pivoting body 31 is pivoted to the clamping head 32. The pivoting body 31 and the clamping head 32 are each formed with a clamping end 313, 321, and the two clamping ends 312 and 321 are opposite to each other. The clamping head 32 is pivoted to one end of the control body 33, and the control body 33 is pivoted to one end of the adjustment rod 34. The other end of the adjustment rod 34 abuts against the screw 311 of the pivoting body 31. Two ends of the spring 35 are connected to the pivoting body 31 and the clamping head 32, respectively, so as to control the control body 33 to pivot relative to the adjustment rod 34. Meanwhile, the control body 33 drives the clamping head 32 to pivot relative to the pivoting body 31, and then the pivoting motion of the clamping head 32 causes expansion and compression of the spring 35.

The two clamping plates 40 are respectively fixedly connected to the clamping ends 313, 321 of the clamping head 32 and the clamping end 312 of the hose clamp pliers 30 and located opposite each other. When the clamping head 32 pivots relative to the pivoting body 31, the relative position of the two clamping ends 312, 321 can be controlled to make the two clamping plates 40 approach each other to perform a clamping action. Each of the clamping plates 40 includes an inner surface 41, an outer surface 42, two opposite lateral surfaces 43, a free end surface 44 and a connecting end surface 45 opposite the free end surface 44. The two lateral surfaces 43 are located at both sides of the inner and outer surfaces 41, 42. The clamping ends 313, 321 of the hose clamp pliers 30 are fixed to the outer surfaces 42 of the two clamping plates 40, and the two inner surfaces 41 of the two clamping plates 40 are opposite each other. Each of the connecting end surfaces 45 is located between the two lateral surfaces 43 and connected to the clamping head 32 and the pivoting body 31, respectively. Each of the free end surfaces 44 is located between the two lateral surfaces 43. On the inner surface 41 of the each of the clamping plates 40 are formed a plurality of protrusions 46 which are arranged spaced along the two opposite lateral surfaces 43, the free end surface 44 and the connecting end surface 45, and each two neighboring protrusions 46 defines a gap 47. The protrusions 46 of one clamping plate 40 are located corresponding to the protrusions 46 on the other clamping plate 40, and the gaps 47 of one clamping plate 40 are located corresponding to the gaps 47 on the other clamping plate 40. The lines for connecting each two opposite protrusions 46 along the two opposite lateral surfaces 43 are defined as lateral connecting lines L1, and the lines for connecting each two opposite protrusions 46 along the free end surface 44 and the connecting end surface 45 are defined as end-surface connecting lines L2. The inner surface 41 of the respective clamping plates 40 is further formed with a plurality of protrusions 48 which are located at the points where the lateral connecting lines L1 cross the end-surface connecting lines L2.

The pair of hose clamp pliers 30 in accordance with the present invention is used to clamp a hose clamp 50 which comprises an inner ring portion 51 and an outer ring portion 52. The inner ring portion 51 is formed by bending an elongated plate into a ring shape. One end of the inner ring portion 51 is bifurcated to form two first protruding portions 511 and a gap 512 therebetween, and each of the first protruding portions 511 is bent to form a first ear 513. The other end of the inner ring portion 51 is provided with a second protruding portion 514 which is bent to form a second ear 515. The second protruding portion 514 is received in the gap 512 between the two first protruding portions 511. The outer ring portion 52 is also formed by bending an elongated plate into a ring shape. The outer ring portion 52 is mounted outside the inner ring portion 51. When the hose clamp 50 is clamped by the clamping plates 40 of the hose clamp pliers 30, the two first ears 513 are received in the gaps 47 between any two neighboring protrusions 46 of one clamping plate 40, while the second ear 515 is received in a corresponding gap 47 on the other clamping plate 40.

When clamping the hose clamp 50, the hose clamp pliers 30 can fix the clamping head 32 and the pivoting body 31 to make the two clamping ends 313, 321 keep clamping the hose clamp 50, so that the user can use the hose clamp pliers 30 to keep clamping the hose clamp 50 hold by the two clamping plates 40 without exerting a continuous force. During the clamping operation, the two first ears 513 are received in the gaps 47 between any two neighboring protrusions 46 of one clamping plate 40, hence, the protrusions 46 can position the two first protruding portions 511, producing a stable clamping effect.

When in use, the user can press the control body 33 toward the pivoting body 31 to make the two clamping plates 40 approach each other to carry out clamping operation, so as to reduce the distance between the first and second protruding portions 511, 514 while increasing the inner diameter of the inner ring portion 51, so that the hose clamp 50 can be mounted on the hose, and then the user can release the hose clamp pliers 30, the outer ring portion 52 of the hose clamp 50 will be clamped tightly against the inner ring portion 51, which leads to an increase of the distance between the first and second protruding portions 511, 514 and the reduction of the inner diameter of the inner ring portion 51, so that the hose clamp 50 will be clamped tightly against the hose. Furthermore, adjusting the depth at which the screw 311 is screwed in the pivoting body 31 can drive the adjustment rod 34 to move, and then the adjustment rod 34 will move the control body 33 and the clamping head 32, so that the relative position of the clamping end 321 of the clamping head 32 and the clamping end 313 of the pivoting body 31 can be adjusted, thus controlling the distance between the clamping plates 40 fixed on the two clamping ends 313, 321 for adjusting the size of the clamped hose clamp 50.

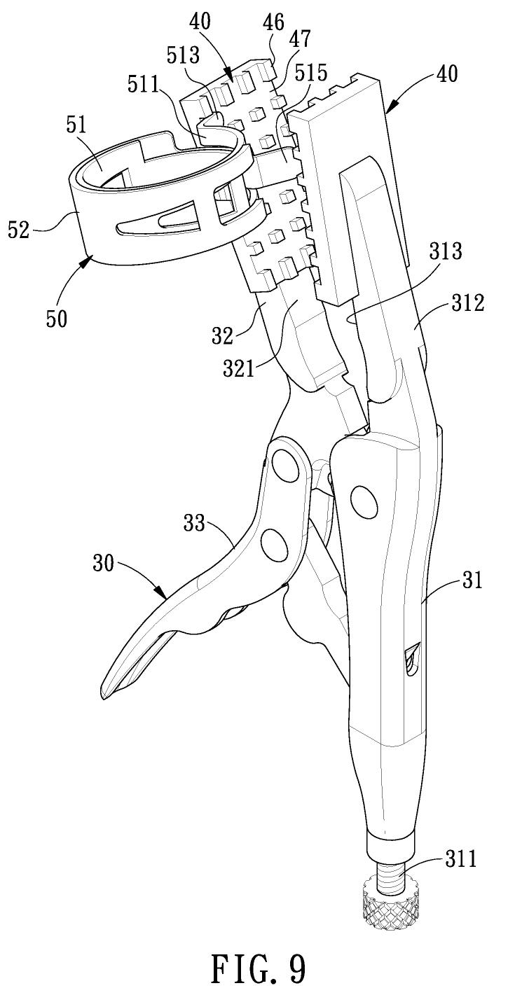

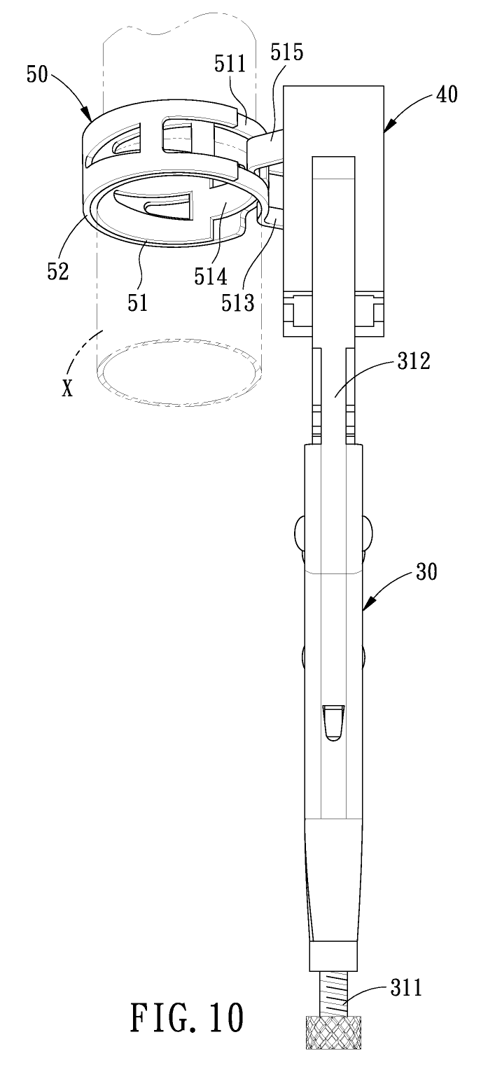

Referring finally to FIGS. 9 and 10, except the connecting end surfaces 45, the hose clamp pliers 30 can use the two opposite lateral surfaces 43, the free end surface 44 of the two clamping plates 40 to clamp the hose clamp 50, that is to say that the hose clamp pliers 30 can clamp in different directions, so that it can be adapted to different work requirements or environments, for example, in a narrow space.

While we have shown and described various embodiments in accordance with the present invention, it is clear to those skilled in the art that further embodiments may be made without departing from the scope of the present invention.

What is claimed is:

1. A pair of hose clamp pliers for clamping a hose clamp, comprising:
a pivoting body, a clamping head, and a control body, the pivoting body being pivoted to the clamping head, and the clamping head being pivoted to one end of the adjustment rod;
two clamping plates being respectively fixedly connected to the pivoting body and the clamping head, each of the clamping plates including an inner surface, an outer surface, two opposite lateral surfaces, a free end surface and a connecting end surface opposite the free end surface, the two lateral surfaces being located at both sides of the inner and outer surfaces of each of the clamping plates, the two clamping ends of the hose clamp pliers being fixed to the outer surfaces of the two clamping plates, and the two inner surfaces of the two clamping plates being opposite each other, each of the connecting end surfaces being located between the two lateral surfaces and connected to the clamping head and the pivoting body, respectively, each of the free end surfaces being located between the two lateral surfaces of each of the clamping plates, on an inner surface of each of the clamping plates being formed a plurality of protrusions which are arranged spaced along the two opposite lateral surfaces, the free end surface and the connecting end surface of each of the clamping plates, and each two neighboring protrusions on each of the clamping plates defines a gap therebetween;
the hose clamp being ring-shaped and comprising two first ears at one end thereof and a second ear at another end thereof, the first and second ears of the hose clamp being capable of inserting between the two clamping plates either from the free end surfaces or the lateral surfaces of the two clamping plates, when the hose clamp is clamped by the clamping plates of the hose clamp pliers, the two first ears are received in the gaps between any two neighboring protrusions of one clamping plate, while the second ear is received in a corresponding gap on another clamping plate.

2. The pair of hose clamp pliers for clamping a hose clamp as claimed in claim 1, wherein the hose clamp including an inner ring portion and an outer ring portion, the inner ring portion being formed by bending an elongated plate into a ring shape, one end of the inner ring portion being bifurcated to form two first protruding portions and a gap therebetween, and each of the first protruding portions being bent to form the first ear, another end of the inner ring portion being provided with a second protruding portion which is bent to form the second ear, the second protruding portion being received in the gap between the two first protruding portions, the outer ring portion being formed by bending an elongated plate into a ring shape, the outer ring portion being mounted outside the inner ring portion.

3. The pair of hose clamp pliers for clamping a hose clamp as claimed in claim 1 further comprising an adjustment rod and a spring, the pivoting body has one end provided with a screw and another end fixed to the clamping head and is pivoted to the clamping head, the pivoting body and the clamping head each have a clamping end, the clamping head is pivoted to one end of the control body, and the control body being pivoted to one end of the adjustment rod, another end of the adjustment rod abutting against the screw of the pivoting body, two ends of the spring being connected to the pivoting body and the clamping head, respectively.

4. The pair of hose clamp pliers for clamping a hose clamp as claimed in claim 3, wherein the clamping plates are respectively fixedly connected to the clamping ends of the clamping head and the clamping end of the pivoting body and the clamping head.

5. The pair of hose clamp pliers for clamping a hose clamp as claimed in claim 1, wherein lines for connecting each two opposite protrusions along the two opposite lateral surfaces of the respective clamping plates are defined as lateral connecting lines, and lines for connecting each two opposite protrusions along the free end surface and the connecting end surface of each of the clamping plates are defined as end-surface connecting lines, the inner surface of the respective clamping plates is further formed with a plurality of protrusions which are located at the points where the lateral connecting lines cross the end-surface connecting lines.
